(19) United States
(12) Patent Application Publication
(10) Pub. No.: US 2019/0008722 A1
(43) Pub. Date: Jan. 10, 2019

(54) TABLET CONTAINERS, UNIT DOSE TABLET PACKAGES, AND METHODS OF MAKING TABLET CONTAINERS AND UNIT DOSE TABLET PACKAGES

(71) Applicant: Monoco LLC, Marina Del Rey, CA (US)

(72) Inventors: Maurice Philip Lospinoso, Culver City, CA (US); Christopher Nolan Lospinoso, Culver City, CA (US)

(21) Appl. No.: 16/037,909

(22) Filed: Jul. 17, 2018

Related U.S. Application Data
(63) Continuation-in-part of application No. 29/599,546, filed on Apr. 4, 2017, now Pat. No. D823113.
Application No. 29/599,546 is a continuation-in-part of application No. 29/599,538, filed on Apr. 4, 2017, now Pat. No. D826549.

(51) Int. Cl. A61J 1/03; B65D 43/02; B65D 83/04

(52) U.S. Cl. CPC A61J 1/03; B65D 5/0209; B65D 83/0445; B65D 43/0235

(57) ABSTRACT

A tablet container includes a rigid jacket with a closed end, an open end, and an interior. A cover is on the open end of the jacket and a desiccant body disposed within the jacket to impound residual moisture retained within the jacket interior subsequent to fixation of the cover to the open end of the jacket. Unit dose tablet packages and methods of making tablet containers and unit dose tablet packages are also described.

### CROSS-REFERENCE TO RELATED APPLICATIONS

This application is a continuation-in-part of and claims priority to U.S. patent application Ser. No. 29/599,546 filed on Apr. 4, 2017 and U.S. patent application Ser. No. 29/599,538 filed on Apr. 4, 2017, each of which is incorporated by reference herein in its entirety.

### BACKGROUND OF THE INVENTION

### 1. Field of the Invention

The present disclosure relates to packaging, and more particularly to tablet containers and unit dose tablet packages, such as for packaging medications, vitamins, and nutritional supplements in hermetically sealed and ruggedized tablet containers.

### 2. Description of Related Art

Pills, such as for medicinal and nutritional purposes, are commonly packaged in bottles or jars for protections. Bottles and jars are generally used to package pills in bulk and typically are sealed from the external environment by a lid to preserve the pills during shipping and storage. The lid generally attaches to the bottle or jar with threads or a snap and may form, or cooperate with, a seal the separate the pills from the external environment. When it is necessary to dispense pills from the bottle or jar the seal is broken and the lid removed, and pills dispensed from the jar or bottle until the pill supply is exhausted or the pills reach their expiration date, at which point the remaining pills are discarded.

One challenge to such conventional bottle and jar packaging systems is exposure of the residual pills to the ambient atmosphere when the bar or jar is initially opened, and thereafter re-opened for dispense additional pills from the bottle or jar. Humidity, for example, in the ambient environment can enter the bottle or jar once opened and condense on the pills, potentially interacting with certain compositions in the pills. For some pills, such as vitamins and nutritional supplements, the moisture can cause compositions located at the pill surface to oxidize, thereby causing the appearance of the pills to change over time. The appearance change can be cosmetic, in which case the change is benign (though potentially unsettling). In some vitamins and nutritional supplements the oxidation can be associated with a reduction in the potency and/or the efficacy of the pill, potentially shortening the shelf life of the vitamins or nutritional supplements in the bottle or jar once opened. The same can hold true for pills containing medications, with similar concerns relating to appearance, potency, and/or efficacy.

One approach to this problem is blister packaging. Blister packages generally allow for packing pills separately, typically with a plastic housing with a foil or card stock backing. The blister package generally retains each of the pills is a separate chamber and allows each pill to be sequentially dispensed as desired by pressing the plastic face such that the pill punctures the foil backing. While generally satisfactory for it intended purpose, blister packages can be relatively fragile, such as from inadvertent puncture of the foil backing by rough handling. Blister packages are also typically employed for packaging pills in bulk, which can require traveling with more pills than necessary for the duration of the travel.

Accordingly, there is still a need in the art for improved tablet containers, unit dose tablet packages, and methods of making tablet containers and unit dose tablet packages. The present disclosure provides a solution for this need.

### SUMMARY OF THE INVENTION

A tablet container includes a rigid jacket with a closed end, an open end, and an interior. A cover is on the open end of the jacket and a desiccant body disposed within the jacket to impound residual moisture retained within the jacket interior subsequent to fixation of the cover to the open end of the jacket.

In certain embodiments the interior of the jacket can be sized such that only a single tablet can be disposed within the interior of the jacket. The jacket can be crush-proof. The jacket can be formed from an inedible material. The jacket can include a polymeric material. The polymeric material can be selected from a group including a monomer, a polyethylene, a polyethylene, a polystyrene, a polyvinylchloride, and a nylon.

In accordance with certain embodiments the jacket can be cylindrical in shape. The jacket can have a frusto-conical shape. The frusto-conical shape can taper from the open end to the closed end of the jacket. The frusto-conical shape can have a length that is greater the length of a standard size tablet or capsule. The frusto-conical shape can have a length that is less than twice the length of a standard size tablet or capsule.

It is contemplated that, in accordance with certain embodiments, that the open end of the jacket can have a rim extending laterally about the open end of the jacket. The rim can extend about an aperture and the aperture can be in communication with the interior of the jacket for dispensing therefrom a tablet. It is also contemplated that that the closed end of the jacket can have a planar surface. The planar surface can be arranged for marking the jacket with an indicia. The indicia can be molded, embossed, or printed on the planar surface. The indicia can include information relating to a tablet hermetically sealed within the interior of the jacket. The indicia can include a quick response (QR) code.

In certain embodiments the cover can be generally oblong in shape. The cover can have a pull-tab body with a sealing portion and a lever (or pull) portion. The sealing portion can abut the open end of the jacket. The desiccant body can fix the cover to the open end of the jacket. The desiccant body can hermetically separate the interior of the jacket from external environment. The desiccant body can be disposed on the sealing portion so as to fix the cover to the open end of the jacket and hermetically separate the interior of the jacket from external environment.

In further embodiments the lever portion of the pull-tab body can be laterally offset from the sealing portion. The cover can be formed from a flexible material. The cover can be formed from a rigid material. The cover can be formed from both a flexible material and a rigid material. In this respect the cover can include a rigid pull-tab overlaying a flexible pull tab body, the flexible pull-tab body arranged between the open end of the jacket and the rigid pull-tab body. Examples of suitable flexible materials include metallic foil, such as aluminum and aluminum alloy foil. Examples of suitable rigid materials include polymeric materials, such as monomer, polyethylene, polystyrene, polyvinylchloride, and nylon.

In accordance with certain embodiments the cover can have a periphery. The cover periphery can have a first arcuate segment with a first radius of curvature. The first radius of curvature can correspond, e.g., match, an external radius of curvature of the open end of the jacket. The cover periphery can have a second radius of curvature. The second radius of curvature can be arranged on an end of the cover longitudinally opposite the first arcuate segment. The second radius of curvature can be smaller than the first radius of curvature. A first lateral segment of the cover periphery can extend between the first arcuate segment and the second arcuate segment. A second lateral segment of the cover periphery can be laterally opposite the first lateral segment. The second lateral segment can extend between the first arcuate segment and the second arcuate segment. The second lateral segment can be oblique relative to the first lateral segment.

It is contemplated that the cover can have a closure surface and an opposite indicia surface. The closure surface can abut the open end of the jacket. The indicia surface can have an indicia disposed thereon. The indicia can include information associated with a tablet hermetically sealed within the interior of the jacket, for example a QR code. The desiccant body can be fixed to the closure surface of the cover. A single tablet can be disposed within the interior of the jacket. The single tablet can include one or more of a medication, a vitamin, or a nutritional supplement. The single tablet can include a composition or material that oxidizes upon exposure to moisture and/or light.

It is also contemplated that, in accordance with certain embodiments, the desiccant body bounds the open end of the jacket. The desiccant body can be disposed between the cover and a rim extending about the open end of the jacket. The desiccant body can bound the open end of the jacket and be disposed between the cover and a rim extending about the open end of the jacket. The desiccant body can include a desiccant material for impounding moisture disposed within the jacket interior subsequent to sealing the tablet container from the external environment. The desiccant body can include an adhesive material for retaining the cover against the open end of the jacket subsequent to sealing the tablet container from the external environment. The desiccant body can include both a desiccant material for impounding moisture disposed within the jacket interior subsequent to sealing the tablet container from the external environment and an adhesive material for retaining the cover against the open end of the jacket subsequent to sealing the tablet container from the external environment.

In certain embodiments the desiccant body can be a first desiccant body and the tablet container can include a second desiccant body. The second desiccant body can be arranged at an end of the jacket opposite the first desiccant body. The second desiccant body can be disposed within the interior of the jacket and adjacent the open end of the jacket body. The jacket can have an interior shelf. The interior shelf can extend about the interior of the jacket. The interior shelf can be adjacent to the closed end of the jacket. A desiccant basket can be disposed within the interior of the jacket. The desiccant basket can be supported by the interior shelf of the jacket. A lid can be seated on the desiccant basket. The lid can be disposed between the interior shelf and the open end of the jacket. The lid can have two or more vents extending therethrough to provide fluid communication between the interior of the basket and the remainder of the interior of the jacket.

A unit dose tablet package includes a tablet container as described above. The jacket has a frusto-conical shape extending between the open end and the closed end of the jacket. The frusto-conical shape has a length that is greater the length of a standard size tablet or capsule and that is than twice the length of the standard size tablet or capsule. The jacket is also crush-proof and is formed from a polymeric material. The cover includes a pull-tab body having a sealing portion abutting the jacket open end and a lever portion laterally offset from the sealing portion. The cover is formed from a flexible material and a rigid material, the flexible material including a metallic foil abutting the open end of the jacket and extending laterally therefrom, and the rigid material including a polymeric material overlaying the open end of the jacket and extending laterally therefrom. The desiccant body bounds the open end of the jacket and is disposed between the cover and a rim extending about the open end of the jacket. The desiccant body includes a desiccant material, which impounds moisture disposed within the jacket interior subsequent to sealing the tablet container from the external environment and an adhesive material, which retains the cover against the open end of the jacket subsequent to sealing the tablet container from the external environment. An interior shelf extends about the interior of the jacket and closed end of the jacket. A desiccant basket is disposed within the interior of the jacket and supported by the interior rim of the jacket. A lid is seated on the desiccant basket between the interior shelf and the open end of the jacket, the lid having a plurality of vents for fluid communication between a desiccant body disposed within the desiccant basket and the interior of the jacket. A single tablet is disposed within the interior of the jacket, the single tablet having at least one of a medication, a vitamin, a nutritional supplement, and/or a composition or material that oxidizes upon exposure to moisture and/or light.

A method of making a single-serving tablet jacket includes inserting the tablet into an interior of a cylindrical container. A desiccant body is affixed to an interior surface of a cover. The cover is registered to a cover end of the cylindrical container such that at least a portion of the desiccant body is between the cover and the cover end of the housing. The tablet is then hermetically sealed within the cylindrical container by the desiccant body for impounding moisture from the interior of the housing.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIGS. 1 and 2 are perspective views of an exemplary embodiment of a tablet container with a jacket with a cover constructed in accordance with the present disclosure, showing the tablet container in a sealed state and an unsealed state with a single tablet therein, respectively;

FIGS. 3 and 4 are plan views of the jacket of the tablet container of FIG. 1, showing closed and open ends of the jacket of the tablet container, respectively;

FIGS. 5 and 6 are side and perspective view of the jacket of FIG. 1, shown the frusto-conical shape and rim of the jacket, respectively;

FIG. 7 is an exploded view of unit dose tablet package including the tablet container of FIG. 1, showing a tablet in size relation to the jacket and the cover according to an exemplary embodiment;

FIGS. 8-10 are perspective and plan views of the cover of the tablet container of FIG. 1, showing the outer surface and jacket surfaces of the cover, respectively;

FIGS. 11-13 are partial cross-sectional views of the tablet container of FIG. 1, showing a the desiccant body mechanically and/or adhesively affixing the cover to the jacket, respectively;

FIG. 14 is a perspective view of an embodiment of the tablet container of FIG. 1 having a rigid and a flexible pull tab cover, the cover removed and inverted in relation to the jacket;

FIGS. 15-20 are cross-sectional, exploded, and perspective views of another embodiment of a tablet container, showing a desiccant basket arranged within the jacket interior;

FIGS. 21-23 are exploded and perspective views of a housing body and a lid for seven single-tablet containers, showing a housing body with seven tablet container pockets and a lid for retaining seven single-tablet containers within the housing body;

FIG. 24 is an exploded view of a housing body and a lid for 30 single-tablet containers, showing a housing body with 30 tablet container pockets and a lid for retaining 30 single-tablet containers within the housing body;

FIG. 25 is an exploded view of a housing body and a lid for 90 single-tablet containers, showing a housing body with 90 tablet container pockets and a lid for retaining 90 single-tablet containers within the housing body; and

FIG. 26 is a block diagram of a method of making a tablet container, showing steps of the method.

### DETAILED DESCRIPTION OF THE PREFERRED EMBODIMENTS

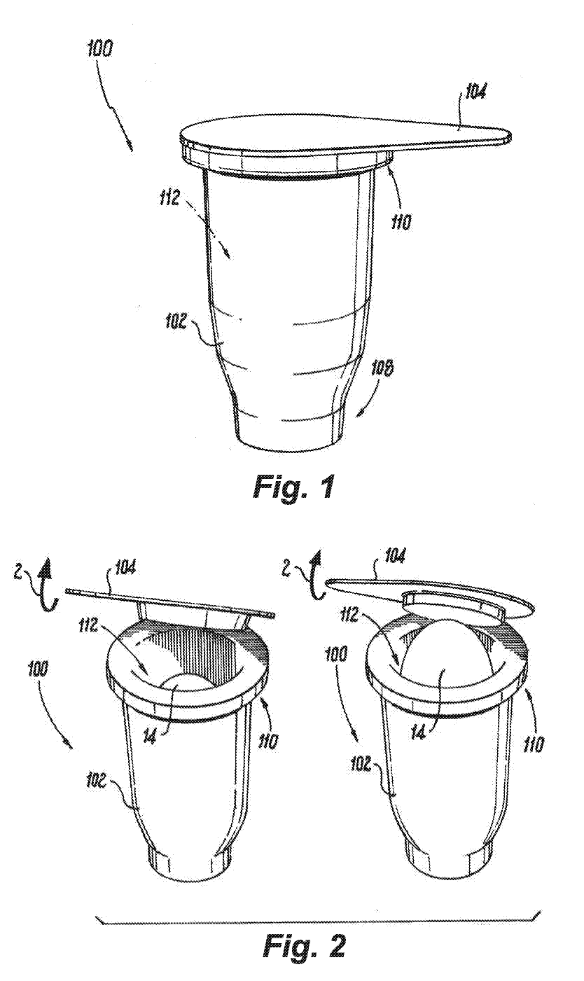

Reference will now be made to the drawings wherein like reference numerals identify similar structural features or aspects of the subject disclosure. For purposes of explanation and illustration, and not limitation, a partial view of an exemplary embodiment of a tablet container in accordance with the disclosure is shown in FIG. 1 and is designated generally by reference character 100. Other embodiments of tablet containers, unit dose tablet packages (e.g., single serving), and methods of making tablet containers and unit dose tablet packages in accordance with the disclosure, or aspects thereof, are provided in FIGS. 2-26, as will be described. The systems and methods described herein can be used for storing tablets, such as medications or nutritional supplements having compositions prone to oxidation, in ruggedized tablet containers as unit dose packages, though the present disclosure is not limited medications, nutritional supplements, or to tablets containing compositions or materials prone to oxidation in general.

Referring to FIGS. 1 and 2, tablet container 100 is shown in a hermetically sealed state and an open state, respectively. Tablet container 100 includes a jacket 102, a cover 104, and a desiccant body 106 (shown in FIG. 2). Jacket 102 is rigid and includes a closed end 108, an open end 110, and an interior 112 (shown in FIG. 2). Cover 104 is seated on open end 110 of jacket 102. Desiccant body 106 fixes cover 104 to open end 110 of jacket 102 and hermetically separates interior 112 of jacket 102 from the external environment 10. In the closed state shown in FIG. 1, fixation of desiccant body 106 to open end 110 of jacket 102 allows desiccant body 106 to impound residual moisture 12 captive within jacket interior 112 subsequent to fixation of cover 104 to open end 110 of jacket 102. In the open state, shown in FIG. 2, interior 112 of tablet container is unsealed and interior 112 accessible such a tablet 14 can be dispensed from tablet container 100. Tablet container 100 is opened, for example, by peeling away or prying away 2 cover 104 from jacket 102. As will be appreciated by those of skill in the art in view of the present disclosure, this breaks the seal between desiccant body 106 and jacket 102 to provide access to interior 112 of jacket 102. Examples of suitable tablet containers include J® pill dispensers and THE JACKET® tablet containers, available from Monoco LLC of Las Vegas, Nev.

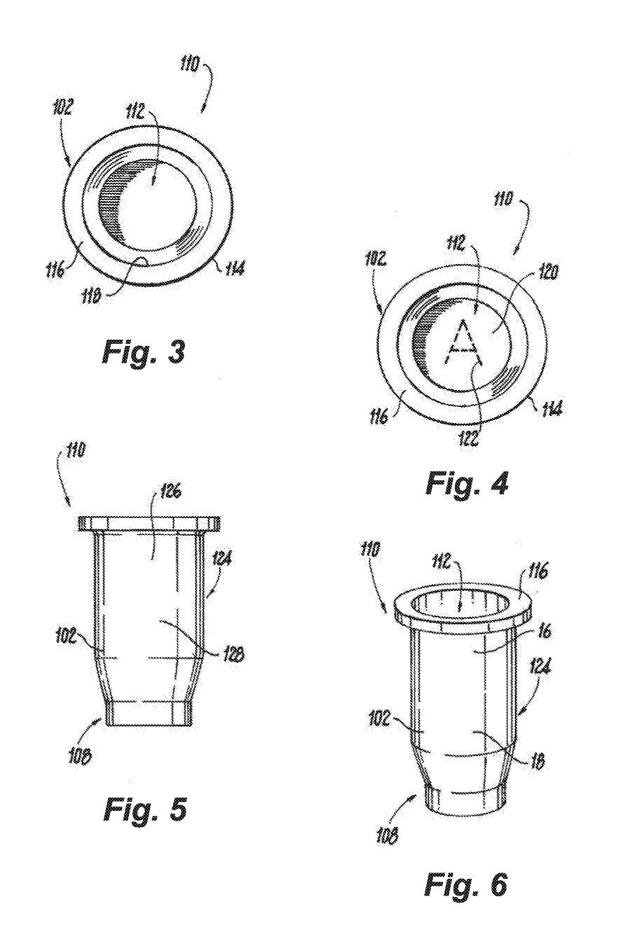

With reference to FIGS. 3 and 4, jacket 102 is shown in top and bottom plan views. Jacket 102 has a cylindrical shape 114. At open end 110 the outer periphery of a rim 116 extends about open end 110 to define cylindrical shape 114. The inner periphery of rim 116 bounds an aperture 118, which is in communication with interior 112 for inserting in and dispensing from tablet container 100 tablet 14. At closed end 108 jacket 102 has a planar surface 120 with a generally circular periphery. As will be appreciated by those of skill in the art in view of the present disclosure, cylindrical shape 114 of jacket 102 provides relatively high crush-resistance 16 (shown in FIG. 6) to tablet container 100. As will also be appreciated by those of skill in the art in view of the present disclosure, rim 116 can also provide additional crush-resistance 16 to tablet container 100. In certain embodiments planar surface 120 includes a marking structure 122.

Marking structure 122 can include printing, a molded or embossed recess, or a molded or embossed raised structure. It is contemplated that marking structure 122 can include an indicia associated with a tablet hermetically sealed within interior 112 of jacket 102, such as an expiration date and/or identity of tablet 14 hermetically sealed within interior 112. In certain embodiments marking structure 122 includes a quick response (QR) code. Dedicating space on jacket 102 for a QR code provides security, at the tablet level, as information indicating details about the manufacture, batch, born on/expiration date, destination, designated user, etc. can be physically carried by jacket 102.

Referring to FIGS. 5 and 6, jacket 102 is shown in side elevation and perspective views. As shown in FIGS. 5 and 6, jacket 102 has a generally frusto-conical shape 124 when viewed in side elevation. Frusto-conical shape 124 tapers from open end 110 to closed end 108, a diameter of the periphery of closed end 108 being smaller than a diameter of the periphery of open end 110. Embodiments having frusto-conical shape 124 can be relatively strong for a given material and wall thickness in comparison to alternative shapes. In certain embodiments jacket 102 can be formed with strength sufficient that tablet container 100 is crush-proof 18, i.e., is able to withstand crushing forces greater than that of crush-resistant tablet containers. It is contemplated that, in certain embodiments, jacket 102 (and tablet container 100) be waterproof.

It is contemplated that jacket 102 be formed from a material that is non-toxic, leach-proof, non-reactive (i.e. inert), and can withstand the conditions of the hermetic sealing process during manufacture to tablet container 100. Further, the material forming jacket 102 can be selected such that jacket 102 be able to withstand conditions of sterilization. In certain embodiments the material forming jacket 102 is selected such that jacket 102 can withstand multiple sterilization cycles, jacket 102 thereby being suited for reuse subsequent to dispensing tablet 14.

In certain embodiments jacket 102 includes a polymeric material 128. Polymeric material 128 can include one or more of a monomer, a polyethylene, a polyethylene, a polystyrene, a polyvinylchloride, and a nylon. Such materials have the advantage that tablet container 100 can be cheaply constructed therefrom in volume, such as through employment of an injection molding technique, as well as additive manufacturing, such as through a stereo lithography technique. As will be appreciated by those of skill in the art in view of the present disclosure, additive manufacturing techniques allow for rapid prototyping the configuration of jacket 102, e.g., wall thickness, etc., for certification and qualification purpose without the cost and delay required to fabricate molds and other associated tooling.

In accordance with certain embodiments jacket 102 can be formed from an inedible material 126. Inedible materials have the advantage that tablet containers constructed therefrom are resistant to pest damage, such as from insects and animals, which could otherwise disrupt the hermetic sealing of tablet 14 within tablet container 100. This allows tablet container 100, and more particularly unit dose tablet package 300 (shown in FIG. 1), to retain tablet 14 in a hermetically sealed state within interior 112 of jacket 102.

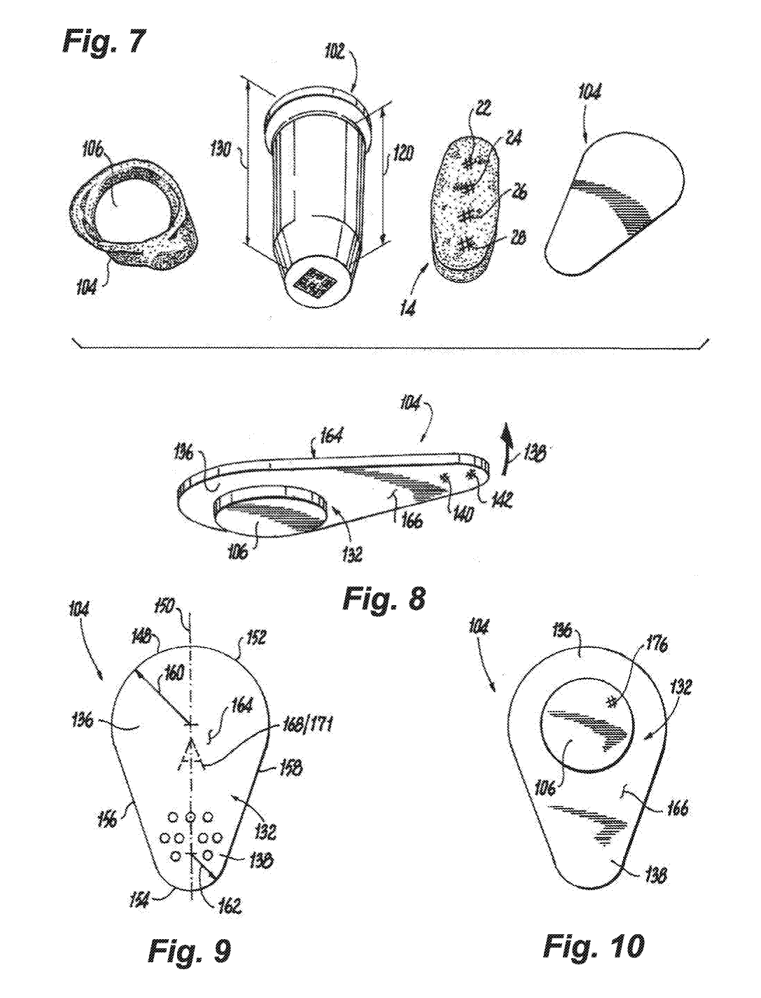

With reference to FIG. 7, jacket 102 is shown in size relation to tablet 14 with cover 104 removed according to an exemplary embodiment. As shown with dimension lines associated with jacket 102 and tablet 14, frusto-conical shape 124 has a height 130 that is greater than a length 20 of tablet 14. Having height 130 that is greater than length 20 of tablet 14, jacket 102 is able to receive within its interior 112 tablet 14. As also shown with the dimension lines associated with jacket 102 and tablet 14, height 130 of frusto-conical shape 124 is less than twice length 20 of tablet 14. Having height 130 that is less than twice length 20 of tablet 14, jacket 102 is only able to receive a single tablet 14 within interior of 112 of jacket 102. This limits the size of tablet container 100, facilitating travel with tablet container 100 by minimizing the associated size and weight of tablet container 100. The size relationship also allows introduction of desiccant body 106 into interior 112 of jacket 102.

As will be appreciated by those of skill in the art in view of the present disclosure, certain compositions contained within tablets can oxidize upon exposure to moisture captive within the interior of a tablet container or packaging. For example, with respect to tablet 14, one or more of a medication 22, a vitamin 24, a nutritional supplement 26, and/or a composition or material prone to oxidation 28 within tablet can react to residual moisture 12 captive within interior 112 of jacket 112. Such reactivity can be relatively benign, for example being limited in effect to cosmetic change in the appearance of tablet 14. Such reactivity can also reduce potency of compositions within tablet 14, potentially limiting the shelf life of tablet 14. To limit the effect of residual moisture 12 on tablet 14 interior 112 is loose-fit to tablet 14. In this respect the interior contour of jacket 112 allows moisture to migrate to desiccant body 106, which is affixed to jacket surface 166, and which impounds within its interior. In certain embodiments desiccant body 106 contacts a portion of tablet 14, desiccant body thereby wicking residual moisture 12 from the surface of tablet 14 by drawing moisture across the tablet surface (and through open space between the tablet and interior surface of jacket 102) and into desiccant body 106.

With reference to FIG. 8, cover 104 is shown in a perspective view. Cover 104 has a cover surface 164, an opposite jacket surface 166, and has an oblong shape 132. It is contemplated that oblong shape 132 be selected such that cover 104 forms a pull-tab body 134. Pull-tab body 134 has a sealing portion 136 and a lever (or pull) portion 138. Sealing portion 136 substantially conforms in shape to open end 110 of jacket 102, abuts open end 110 of jacket 102, and has disposed thereon desiccant body 106.

Lever portion 138 is laterally offset from sealing portion 136. It is contemplated that lever portion 138 be configured and adapted for removing cover 104 from jacket 102. In this respect lever portion 138 can have a length selected to provide sufficient leverage for deliberate, but not inadvertent, removal of cover 104 from jacket 102. Alternatively (or additionally), lever portion 138 can have a no-slip feature such as raised structures to facilitate grasping lever portion 138 for removal of cover 104 from jacket 102.

In certain embodiments cover 104 can include a flexible material 140. Examples of flexible materials include metallic foil, such as metallic foil formed from aluminum or aluminum alloy. In accordance with certain embodiments cover 104 can be formed from a rigid material 142. Examples of suitable rigid materials include polymeric materials, such as certain monomers, polyethylene, polystyrene, polyvinylchloride, and nylon materials. In this respect jacket 102 and cover 104 can be formed from a common rigid material. As above, this allows cover 104 to be formed using an injection molding technique, allowing for relatively low cost manufacture of cover 104 in volume as well as fabrication of cover 104 using additive manufacturing techniques, the latter allowing for the fabrication of cover 104 rapidly, such as for certification and/or qualification, without the need to fabricate associated molds and/or tooling.

Referring now to FIG. 10, cover surface 164 of cover 104 is shown. The pull-tab body of cover 104, e.g., rigid pull-tab body 144 and/or flexible pull-tab body 146, is bounded by a periphery 148. Periphery 148 defines a cover longitudinal axis 150 that spans both sealing portion 136 and lever portion 138, and includes a plurality of segments connected to one another that bound cover 104. In the illustrated exemplary embodiment periphery 148 includes a first arcuate segment 152, a second arcuate segment 154, a first lateral segment 156, and a second lateral segment 158. Although described herein with respect to four segments having particular geometry it is to be understood and appreciated that other geometries are possible and remain within the scope of the present disclosure.

First arcuate segment 152 has first radius of curvature 160. First radius of curvature 160 extends from a location along cover longitudinal axis 150 and extends along a portion of cover 104 to define first arcuate segment 152 of periphery 148. It is contemplated that first radius of curvature 160 corresponds to the curvature of the outer periphery of rim 116 such that the portion of cover periphery 148 is in registration with a portion of the outer periphery of rim 116. This reduces the risk of cover 104 being removed inadvertently from jacket 102, such as due to handling or activity by a user prior to dispensing tablet 14 from jacket 102.

Second arcuate segment 154 is arranged on a side of periphery 148 longitudinally opposite first arcuate segment 152 and has a second radius of curvature 162. Second radius of curvature 162 extends from a location on cover longitudinal axis 150 and defines a portion of periphery 148 longitudinally opposite first arcuate segment 152. It is contemplated that second radius of curvature 162 be selected to facilitate removal of cover 104 from jacket 102. In this respect second radius of curvature 162 can vary in size relative the size of tablet 14 hermetically sealed within jacket 102. For example, in certain embodiments second radius of curvature 162 can be greater than first radius of curvature 160. In accordance with certain embodiments, second radius of curvature 162 can be smaller than first radius of curvature 160.

First lateral segment 156 extends along cover longitudinal axis 150 and connects first arcuate segment 152 with second arcuate segment 154. More particularly, first lateral segment 156 extends from an end of first arcuate segment 152 to an end of second arcuate segment 154, these respective ends and first lateral segment 156 being located on a common side of cover longitudinal axis 150. Second lateral segment 158 is located on a side of cover 104 opposite first lateral segment 156, second lateral segment 158 connecting ends of first arcuate segment 152 and second arcuate segment 154 located on a lateral side cover longitudinal axis 150 opposite first lateral segment 156. Second lateral segment 158 is additionally angled relative to first lateral segment 156, second lateral segment 158 being angled obliquely relative to first lateral segment 156. In the illustrated exemplary embodiment lines defined by first lateral segment 156 and second lateral segment 158 intersect at a location on a side of lever portion 138 opposite cover sealing portion 136.

It is contemplated that cover surface 164 can be used for marking purposes. In this respect an indicia 168 including a marking structure 171 can be disposed on cover surface 164. The marking structure 171 can include printing, a raised or embossed feature, or recess or embossed feature. The indicia 168 formed by marking structure can include information associated with tablet 14 hermetically sealed within interior 112 of jacket 102. For example, indicia 168 can indicate the expiration date and/or the expiration date of tablet 14. Indicia 168 can include either (or both) of machine-readable structures, e.g., a bar code, and user readable, such as letters and numbers.

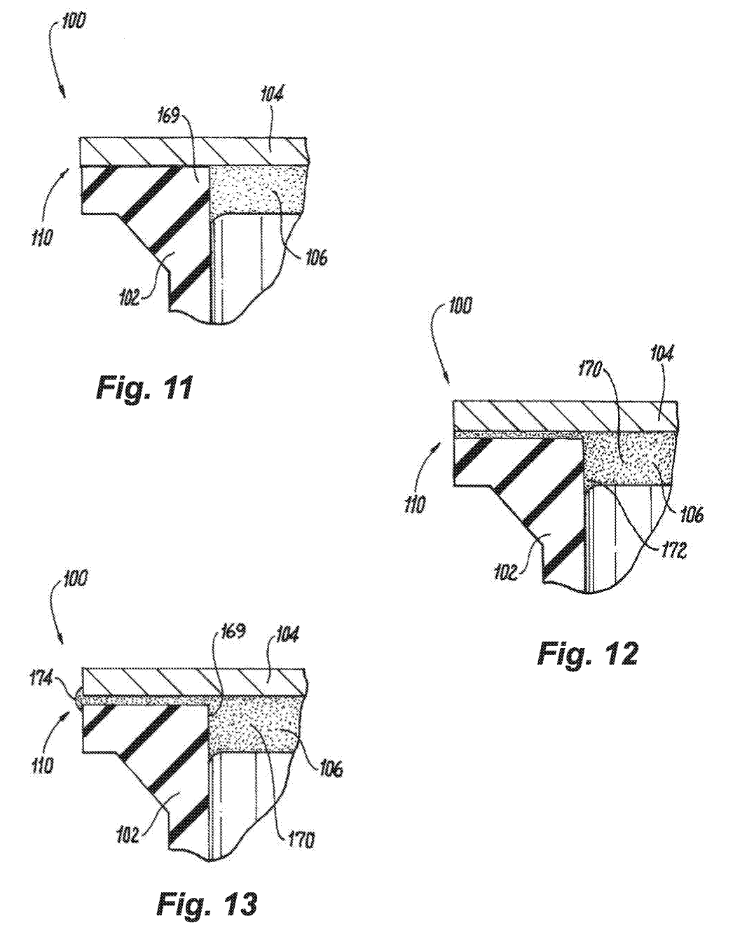

Referring to FIG. 11, jacket surface 166 of cover 104 is shown. Desiccant body 106 is disposed on jacket surface 166 of cover 104 and includes a desiccant body 106. Desiccant body 106 includes a desiccant material 176. Desiccant material 176 is hydrophilic and readily absorbs moisture from within the atmosphere contacting desiccant body 106, desiccant body 106 thereby impounding moisture within its interior. It is contemplated that desiccant material 176 include a non-toxic silica type material. Such materials have the advantages that they are non-toxic, leach-proof, non-reactive (i.e. inert), and can withstand the conditions of the hermetic sealing process during manufacture to tablet container 100.

In certain embodiments desiccant body has a disk-like shape with a diameter spanning a width of tablet 14, desiccant body 106 thereby wicking away residual moisture 12 within interior 112 as residual moisture 12 condenses on the surface of tablet 14. As will be appreciated by those of skill in the art in view of the present disclosure, spanning open end 110 of jacket 102 and/or the width of tablet 14 can provide barrier separation of the material forming cover 104, allowing the use of materials in cover 104 that could otherwise be incompatible with tablet 14, such as metals like aluminum by way of non-limiting example.

Desiccant body 106 is affixed to cover 104 at jacket surface 166 such that desiccant body 106 in turn fixes cover 104 to jacket 102. Fixation can be accomplished mechanically, via an interference fit. In this respect, as shown in FIG. 11, desiccant body 106 can bound open end 110 of jacket 102. In certain embodiments desiccant body 106 can be slightly larger than the inner periphery of rim 116, desiccant body 106 thereby affixing cover 104 to jacket 102 with an interference fit 169. As will be appreciated by those of skill in the art in view of the present disclosure, the tightness of interference fit 169 can increase over time as desiccant body swells as a consequence of the collection therein of impounded residual moisture 12.

Fixation can be accomplished adhesively, via an adhesive material 170. It is contemplated that adhesive material 170 includes dispersion adhesive, such as a silicone and/or a polymer-based adhesive material. Such materials have the advantages that they are non-toxic, leach-proof, non-reactive (i.e. inert), and can withstand the conditions of the hermetic sealing process during manufacture to tablet container 100. Further, such materials can be able to withstand conditions of sterilization, and in certain embodiments multiple sterilization cycles.

As shown in FIG. 12, desiccant body 106 can be disposed between cover 104 and jacket 102. More particularly, desiccant body 106 can be between cover surface 164 and rim 116 extending about open end 110. In this respect desiccant body 106 can additionally include an adhesive material 170, adhesive material causing desiccant body 106 to adhere to both jacket surface 166 of cover 104 and to rim 116 of jacket 102. As shown in FIG. 13, desiccant body 106 can be oversized in relation to aperture 118 such that, when pressed against rim 116, desiccant body 106 defines a radially inner fillet 172 and a radially outer fillet 174 for fixing cover 104 to jacket 102, fixation thereby being accomplished by both mechanical interference fit 169 and via adhesive material 170.

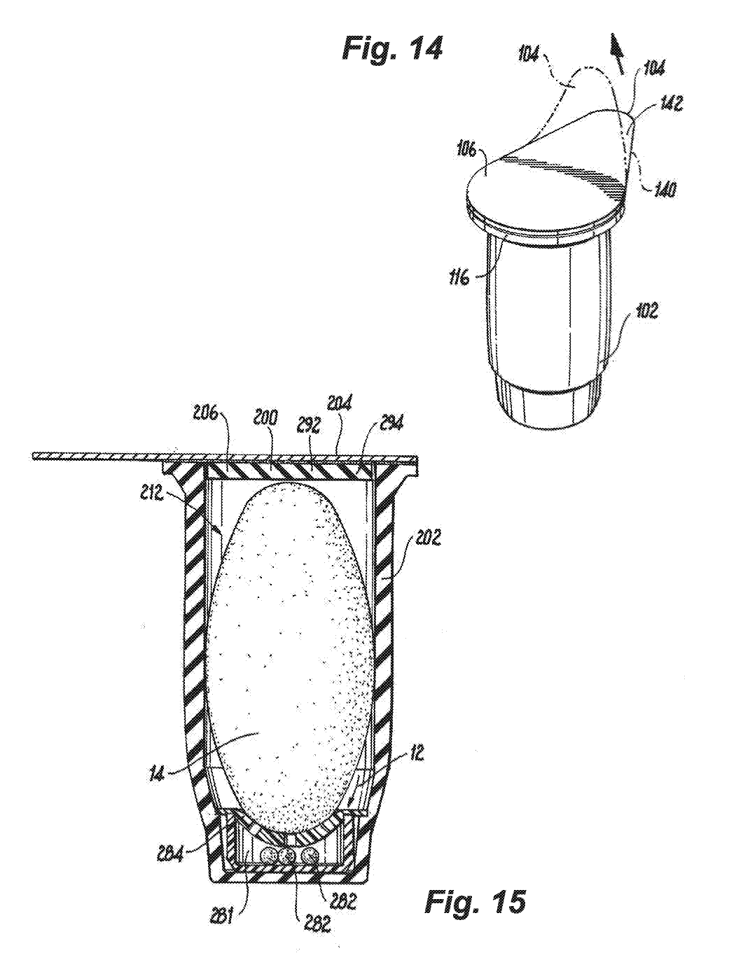

As shown in FIG. 14, it is contemplated that cover 104 can be formed from either (or both) flexible material 140 and rigid material 142. For example, a rigid pull-tab body 144 formed from rigid material 142 can overlay (relative to jacket 102) a flexible pull-tab body 146 formed from flexible material 140. As will be appreciated by those of skill in the art in view of the present disclosure, such stacked cover arrangements can provide both the ability to accommodate both inconsistencies in rim 116 and provide puncture protection and crush-resistance associated with rigid material 142. As also shown in FIG. 14 (illustrated after tablet removal and inverted relative to jacket 102), rigid pull-tab body 144 can be mechanically or adhesively affixed 145 to flexible pull-tab body 146, providing flexibility with respect to assembly process selection.

Referring now to FIGS. 15-20, a tablet container 200 is shown. Tablet container 200 is similar to tablet container 100 (shown in FIG. 1) and additionally has desiccant basket assembly 280 and a seal body 206. Desiccant basket 280 has an open-top basket body 281 and contains within its interior a desiccant body 282. Desiccant body 282 is retained within desiccant basket 280 by a vented lid 284, vented lid 284 having a plurality of vents 286 extending therethrough to provide fluid communication between second desiccant body 282 and the remainder of interior 212 for impounding residual moisture 12 within interior 212. Desiccant body 282 can be a singular desiccant body, a plurality of desiccant bodies, or a sacket containing desiccant in a granular form. As will be appreciated by those of skill in the art in view of the present disclosure, second desiccant body 282 provides additional capability to remove residual moisture 12 from interior 212 of jacket 202. In the illustrated exemplary embodiment vented lid 284 additionally has an arcuate profile, which provides centering of tablet 14 to facilitate wicking away moisture from tablet 14 as residual moisture 12 condenses on the exterior of tablet 14, reducing residence time of the moisture with tablet 14.

Jacket 202 is similar to jacket 102 (shown in FIG. 1) and additionally has an interior shelf 288. Interior shelf 288 extends radially about the interior surface of jacket 202 adjacent to closed end 108 and is configured and adapted to seat desiccant basket 280 as an assembly. In the illustrated exemplary embodiment vented lid 284 engages interior shelf 288, an expansion gap thereby being provided about the exterior of desiccant basket 280 to accommodate swelling of second desiccant body 282. It is contemplated that desiccant basket 280 be loose-fit or press-fit within interior 212 of jacket 202, a loose-fit simplifying assembly and allowing for vertical movement (relative to the drawing sheet) of tablet 14 while press-fit rigidly supporting tablet 14 between vented lid 284 and the first desiccant body of tablet container 200.

Seal body 206 is similar to desiccant body 106 in shape and function with the difference that seal body 206 does not include a desiccant material. In this respect seal body can include a barrier material 290, an adhesive material 292, and/or a telltale material 294. Barrier material 290, an adhesive material 292, and/or a telltale material 294 be non-toxic, leach-proof, non-reactive (i.e. inert), and be able to withstand the conditions of the hermetic sealing process during manufacture to tablet container 200. Telltale material 294 is selected such that, upon breach of jacket interior 102, telltale material 294 rapidly changes color, e.g., form formation of precipitate as a result of a chemical reaction with oxygen or moisture in the ambient environment. As will be appreciated by those of skill in the art in view of the present disclosure, color change in seal body 206 signals the user that tablet 14 has been exposed to the ambient environment and/or that tablet container 200 has been tampered, telltale material thereby providing a safety function.

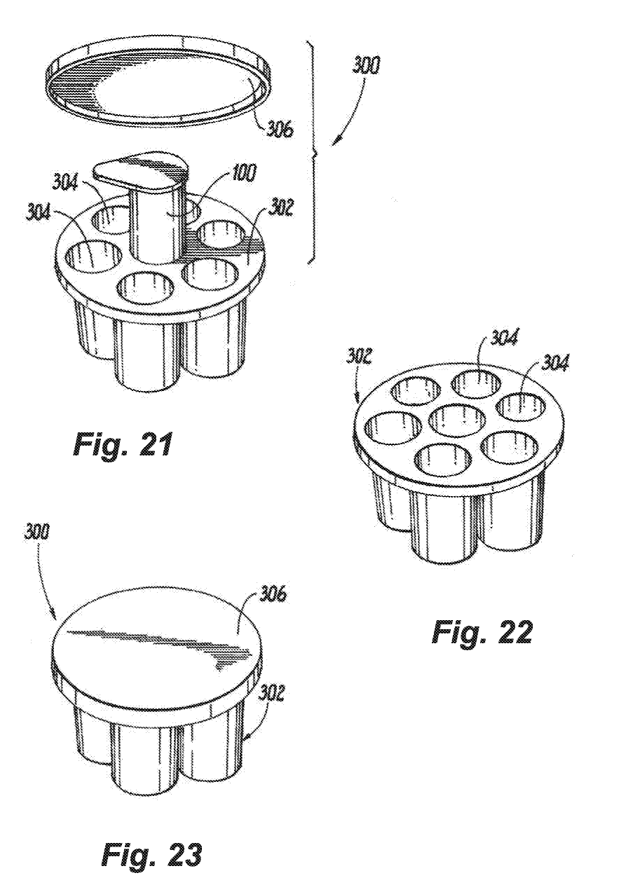

Referring now to FIGS. 21-25, multi-packs for single tablets hermetically sealed within a plurality of tablet containers 100 are shown. As shown in FIGS. 21-23, a 7-tablet multi-pack 300 is shown. 7-tablet multi-pack 300 includes a housing body 304 and a housing lid 306. Housing body 304 has seven pockets 302 sized to removably seat tablet container 100 (shown in FIG. 1). Housing lid 306 fits over housing body 302 and tablet containers 100 to retain each tablet container 100 within a respective pocket 302. As will be appreciated by those of skill in the art, the number of pockets 302 with housing body 304 can be selected according to tablet consumption, 7-tablet multi-pack 300 having seven (7) pockets 304 which serving as a visual cue for usage of a single tablet daily during a one week course.

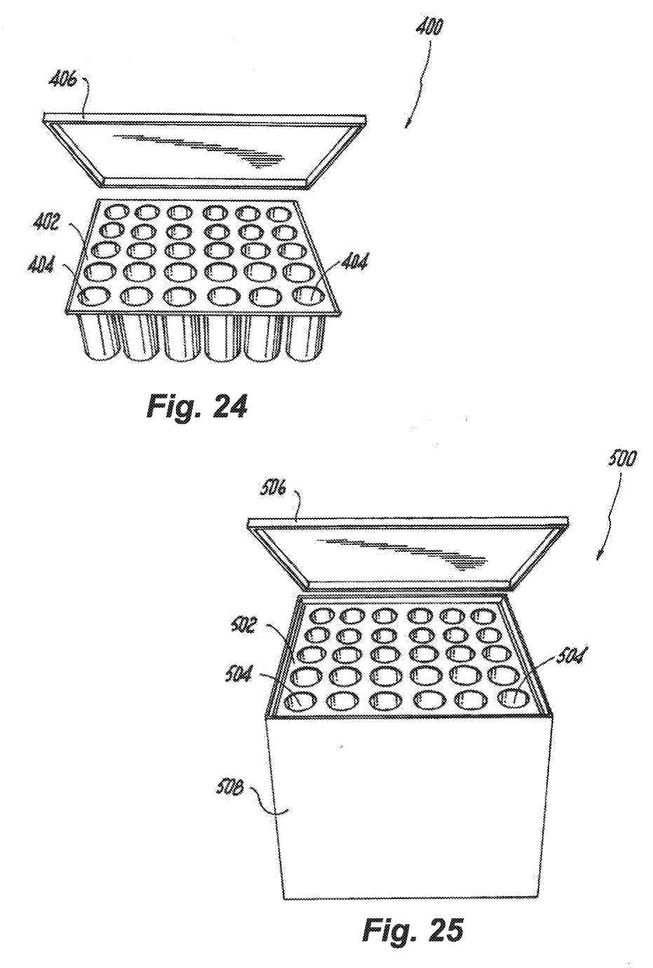

It is contemplated multi-pack body 304 can be customized according to the needs of the user. For example, as shown in FIG. 24, a 30-tablet multi-pack 400 can include a housing body 404 with 30 pockets 402, each sized to seat a respective tablet container 100 (shown in FIG. 1), and a lid 406 seating thereon to retain each tablet container 100 in a respective pocket 402. Similarly, as shown in FIG. 25, a 90-tablet multipack can include 90 pockets 504 in three housing bodies 504 stacked within a box 508, a lid 506 fitting on box 508 to retain therein each of the housing bodies 504 and tablet containers 100.

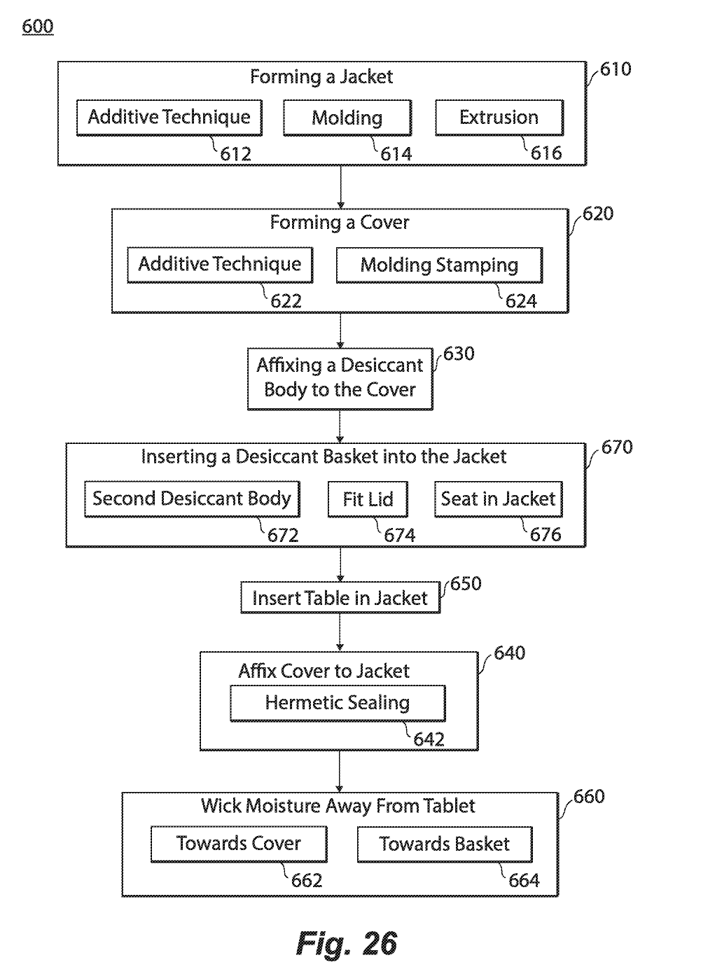

With reference to FIG. 26, a method 600 of making a tablet container, e.g., tablet container 100 (shown in FIG. 1) or tablet container 200 (shown in FIG. 15), is shown. Method 600 includes forming a rigid jacket, e.g., jacket 102 (shown in FIG. 1), as shown with box 610. The jacket can be formed using an additive manufacturing technique, an injection molding technique, or an extrusion technique, as shown with box 612-616. Method 600 also includes forming a cover, e.g., cover 104 (shown in FIG. 1), as shown with box 620. The cover can be formed using an additive manufacturing technique, an injection molding technique, or a stamping technique, as shown with boxes 622-626. A desiccant body, e.g., desiccant body 106 (shown in FIG. 7), is then affixed to a jacket surface of the cover, as shown with box 630, and the cover affixed to the open end of the jacket, as shown with box 640, and the jacket interior hermetically sealed, as shown with box 642. In certain embodiments a singular tablet, e.g., tablet 14 (shown in FIG. 1), is inserted into the jacket prior to affixing the cover to the jacket, as shown with box 650. Residual moisture, e.g., residual moisture 12 (shown in FIG. 1), is wicked away from the tablet using the desiccant body and impounded by the desiccant body, as shown with box 660.

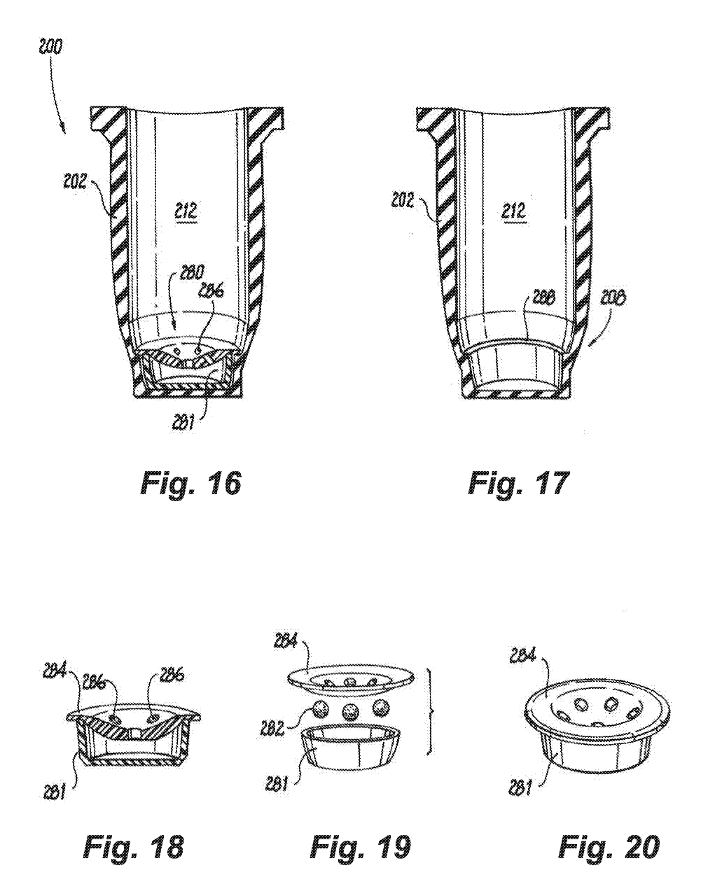

In certain embodiments method 600 additionally includes inserting a desiccant basket, e.g., desiccant basket 280 (shown in FIG. 16), as shown with box 670. The desiccant basket is formed by inserting one or more desiccant bodies, e.g., desiccant body 282 (shown in FIG. 16), into the desiccant body, as shown with box 672. A lid is fit to the desiccant basket, e.g., vented lid 284 (shown in FIG. 16), and the desiccant basket inserted into the interior of the jacket, as shown with box 674 and 676. In such embodiments additional moisture can be impounded from within in the interior of the jacket, as shown with box 660. It is contemplated that the moisture can be wicked away from the tablet in two opposite directions, e.g., towards each of the first and second desiccant bodies, as shown with box 664, such as by including a desiccant material in both seal member 206 (shown in FIG. 15) and the desiccant basket.

The methods and systems of the present disclosure, as described above and shown in the drawings, provide for tablet containers, unit dose tablet containers, and methods of tablet containers with superior properties including extended shelf-life and/or hermetic tablet sealing in ruggedized jackets for storage in harsh environments. While the apparatus and methods of the subject disclosure have been shown and described with reference to preferred embodiments, those skilled in the art will readily appreciate that changes and/or modifications may be made thereto without departing from the scope of the subject disclosure.

1. A tablet container, comprising:
a rigid jacket with a closed end, an open end, and an interior;
a cover seated on the open end of the jacket; and
a desiccant body disposed within the jacket to impound residual moisture retained within the jacket interior subsequent to fixation of the cover to the open end of the jacket.

2. The tablet container as recited in claim 1, wherein the jacket has a frusto-conical shape tapering from the open end to the closed end of the jacket, the frusto-conical shape having a length greater a standard size tablet length and less than twice the standard size tablet length.

3. The tablet container as recited in claim 1, wherein the open end of the jacket has a rim extending about an aperture, the aperture in communication with the interior of the jacket for dispensing therefrom a tablet, wherein the closed end of the jacket has a planar surface for marking tablet container with an indicia associated with a tablet hermetically sealed within the interior of the jacket.

4. The tablet container as recited in claim 1, wherein the jacket is formed from an inedible material, wherein the jacket is crush-resistant or crush-proof.

5. The tablet container as recited in claim 1, wherein the jacket includes a polymeric material selected from a group including monomers, polyethylene, polyethylene, polystyrene, polyvinylchloride, and nylon.

6. The tablet container as recited in claim 1, wherein the cover comprises a pull-tab body having a sealing portion and a lever portion, the sealing portion abutting the open end of the jacket, and lever portion laterally offset from the sealing portion, the desiccant body disposed on the sealing portion so as to fix the cover to the open end of the jacket and hermetically separate the interior of the jacket from external environment.

7. The tablet container as recited in claim 1, wherein the cover includes a flexible material, a rigid material, or both a flexible material and a rigid material.

8. The tablet container as recited in claim 7, wherein the flexible material includes a metallic foil abutting the open end of the jacket and extending laterally therefrom.

9. The tablet container as recited in claim 7, wherein the rigid material includes a polymeric material overlaying the open end of the jacket and extending laterally therefrom.

10. The tablet container as recited in claim 1, wherein the cover includes an indicia surface opposite the closure surface, the indicia surface having an indicia associated with a tablet hermetically sealed within the interior of the jacket.

11. The tablet container as recited in claim 1, wherein the desiccant body fixes the cover to the open end of the jacket and hermetically separating the interior of the jacket from external environment.

12. The tablet container as recited in claim 11, wherein the desiccant body bounds the open end of the jacket.

13. The tablet container as recited in claim 11, wherein the desiccant body is disposed between the cover and a rim extending about the open end of the jacket.

14. The tablet container as recited in claim 11, wherein the desiccant body bounds the open end of the jacket and is disposed between the cover and a rim extending about the open end of the jacket.

15. The tablet container as recited in claim 1, wherein the desiccant body comprises:
a desiccant material for impounding moisture disposed within the jacket interior subsequent to sealing the tablet container from the external environment; and
an adhesive material for retaining the cover against the open end of the jacket subsequent to sealing the tablet container from the external environment.

16. The tablet container as recited in claim 1, wherein cover has a periphery with:
a first arcuate segment with a first radius of curvature;
a second arcuate segment with a second radius of curvature arranged on an end of the cover longitudinally opposite the first arcuate segment, the second radius of curvature being smaller than the first radius of curvature;
a first lateral segment extending between the first arcuate segment and the second arcuate segment; and
a second lateral segment laterally opposite the first lateral segment and extending between the first arcuate segment and the second arcuate segment, the second lateral segment being oblique relative to the first lateral segment.

17. The tablet container as recited in claim 1, wherein the desiccant body is a first desiccant body and further comprising a second desiccant body, the second desiccant body disposed within the interior of the jacket and adjacent the open end of the jacket body.

18. The tablet container as recited in claim 1, wherein the jacket has an interior shelf extending about its interior and adjacent to the closed end of the jacket, and further comprising:
a desiccant basket disposed within the interior of the jacket and supported by the interior rim of the jacket; and
a lid seated on the desiccant basket between the interior shelf and the open end of the jacket, the lid having a plurality of vents for fluid communication between a desiccant body disposed within the desiccant basket and the interior of the jacket.

19. The tablet container as recited in claim 1, further comprising a single tablet disposed within the interior of the jacket, the single tablet having at least one of a mediation, a vitamin, a nutritional supplement, and/or a material that oxidizes upon exposure to moisture and/or light.

20. A unit dose tablet package, comprising:
a tablet container as recited in claim 1, wherein the jacket has a frusto-conical shape extending between the open end and the closed end of the jacket, the frusto-conical shape having a length greater a standard size tablet length and less than twice the standard size tablet length, wherein the jacket is crush-proof and is formed from a polymeric material,
wherein the cover comprises a pull-tab body having a sealing portion abutting the jacket open end and a lever portion laterally offset from the sealing portion,
wherein the cover includes a flexible material and a rigid material, the flexible material including a metallic foil abutting the open end of the jacket and extending laterally therefrom and the rigid material including a polymeric material overlaying the open end of the jacket and extending laterally therefrom,
wherein the desiccant body is disposed bounds the open end of the jacket and is disposed between the cover and a rim extending about the open end of the jacket, the desiccant body comprising:
a desiccant material for impounding moisture disposed within the jacket interior subsequent to sealing the tablet container from the external environment; and
an adhesive material for retaining the cover against the open end of the jacket subsequent to sealing the tablet container from the external environment,
wherein the jacket has an interior shelf extending about its interior and adjacent to the closed end of the jacket;
a desiccant basket disposed within the interior of the jacket and supported by the interior rim of the jacket;
a lid seated on the desiccant basket between the interior shelf and the open end of the jacket, the lid having a plurality of vents for fluid communication between a desiccant body disposed within the desiccant basket and the interior of the jacket; and
a single tablet disposed within the interior of the jacket, the single tablet having at least one of a mediation, a vitamin, a nutritional supplement, and/or a material that oxidizes upon exposure to moisture and/or light.

21. A unit dose multi-pack comprising a plurality of tablet containers as recited in claim 1.

22. The tablet container as recited in claim 1, further comprising a seal member fixing the cover to the open end of jacket, the seal member comprising a telltale material.
